(19) United States
(12) Patent Application Publication
(10) Pub. No.: US 2014/0340804 A1
(43) Pub. Date: Nov. 20, 2014

(54) ELECTROMAGNETIC SWITCH FOR USE WITH ELECTRICAL EQUIPMENT

(71) Applicant: Tripco Limited, Ballinasloe, County Galway (IE)

(72) Inventor: Patrick Ward, Ballinasloe (IE)

(73) Assignee: Tripco Limited, Ballinasloe, County Galway (IE)

(21) Appl. No.: 14/376,167

(22) PCT Filed: Feb. 4, 2013
(86) PCT No.: PCT/EP2013/052111

§ 371 Date: Aug. 1, 2014

(30) Foreign Application Priority Data
Mar. 23, 2012 (IE) S2012/0150
Apr. 4, 2012 (IE) S2012/0173
Apr. 17, 2012 (IE) S2012/0192

(51) Int. Cl. H01H 47/22; H01H 47/32; H01H 89/06; H01H 51/01

(52) U.S. Cl. CPC H01H 47/223; H01H 51/01; H01H 47/325; H01H 89/06
USPC 361/115; 335/137

(57) ABSTRACT

An electromagnetic switch comprises at least one pair of magnetically latchable electrical contacts (12a, 14a) operated by current flowing in an associated coil means (K1, K2), and an electrical circuit arranged to apply a first current in a first direction through the coil means to close the contacts and subsequently to apply a second current in a second, opposite, direction through the coil means to open the contacts. In certain embodiments the coil means comprises first and second independent coils (K1, K2) and the first and second currents flow in opposite direction in the first and second coils respectively. In other embodiments the coil means comprises a single coil (K1) and the first and second currents flow in opposite directions in the single coil.

This application is a 35 USC 371 national phase filing of International Application PCT/EP2013/052111, filed Feb. 4, 2013, which claims priority to Irish national application S2012/0150 filed Mar. 23, 2012, Irish national application S2012/0173 filed Apr. 4, 2012, and Irish national application S2012/0192 filed Apr. 17, 2012, the disclosures of which are incorporated herein by reference in their entireties.

### FIELD OF THE DISCLOSURE

This invention relates to an electromagnetic switch for use with electrical equipment but which may advantageously also be used in an RCD (residual current device) socket outlet, known in the USA as a ground fault circuit interrupt (GFCI) receptacle. The terms RCD and GFCI are used interchangeably herein.

### BACKGROUND

In the present specification an electromagnetic switch is an electrical switch with mechanical contacts which are operated by a magnetic field produced by current flowing in a coil, usually a solenoid. FIG. 1 is a diagram of a resettable electromagnetic (EM) switch of the general kind described with reference to FIG. 7 of European Patent No. 1490884 and U.S. Pat. No. 6,975,191.

Switches used in RCDs can generally be divided into two types, EL types and ML types. EL types are types which require the continuous supply of electrical current through a coil to enable the contacts to be closed and remain closed, and whose contacts open automatically when the coil current falls below a certain level. In that regard they are also responsive to supply voltage conditions. ML types are types which can generally be closed and will remain closed with or without the presence of a supply current.

In FIG. 1 the electromagnetic switch has a pair of fixed contacts 12a, 12b and a pair of movable contacts 14a, 14b mounted on a movable contact carrier (MCC) 16 and opposing the fixed contacts 12a, 12b respectively. An opening spring 18 biases the MCC 16 and moveable contacts 14a, 14b upwardly (as seen in FIG. 1) away from the fixed contacts 12a, 12b into a first rest position. A permanent magnet 22 is retained within the MCC 16. A fixed bobbin 24 has a solenoid coil K1 wound on it and a ferromagnetic plunger 26 extends through the bobbin. A reset button 28 is fitted to the accessible lower end of the plunger 26. The plunger and reset button are biased downwardly towards a first rest position by a reset spring 32. Both the MCC 16 and plunger 26 are shown in their first positions in FIG. 1.

When the reset button 28 is pushed upwards by manual force against the bias of the spring 32 the gap between the plunger 26 and the magnet 22 will be sufficiently reduced so as to allow the plunger to entrain the magnet. When the reset button is released the magnet 22 and MCC 16 will be drawn downwards from their first position by the greater force of the reset spring 32 in opposition to the force of the opening spring 18 until the moving contacts 14a, 14b come to rest on the fixed contacts 12a, 12b respectively and thereby make the electrical connections to power up a load, not shown. Here the contacts 12a, 14a are assumed to be located in the live supply conductor to the load and the contacts 12b, 14b are assumed to be located in the neutral supply conductor to the load.

When a current above a certain release threshold is passed through the coil in a particular direction, the coil K1 will produce an electromagnetic flux which will oppose the flux of the permanent magnet 22 and weaken it to such an extent that, provided the current persists for at least some minimum duration, the magnet 22 will release (detrain) the plunger 26 and the MCC 16 and the plunger 26 will each move back to their first positions by the action of the opening and reset springs respectively and thereby cause the contact pairs 12a, 14a and 12b, 14b to open. By this means the resettable EM switch can be used to connect and disconnect loads in a circuit. The switch of FIG. 1 can be referred to as an ML type because it is held closed (latched) magnetically and does not depend on the mains supply to remain closed. It will be understood that although the contacts 12a, 12b are referred to as fixed, this does not rule out their being spring mounted so that they can “give” resiliently upon engagement by the movable contacts 14a, 14b. The essential point is that they play a passive role in the operation of the device, and the term “fixed” is to be interpreted accordingly. It is also preferred that there be some degree of over-travel remaining in the reset spring 32 to ensure adequate contact pressure and to compensate for contact wear or a reduction in height of either set of contacts so that adequate contact pressure is maintained after a reasonable amount of wear and use.

FIG. 2 is a circuit diagram of a basic RCD (GFCI) circuit incorporating an electromagnetic switch of the kind shown in FIG. 1. In FIG. 2 only the coil K1 is explicitly shown, and the contacts 12a, 14a and 12b, 14b are shown collectively as the load contacts SW1. This type of circuit will be familiar to those versed in the art, but more detailed information can be found on such devices at www.westernautomation.com.

Initially, the load contacts SW1, i.e. the contact pairs 12a, 14a and 12b, 14b, are manually closed by pressing and releasing the rest button 28 as previously described. For reasons which will be explained, it is significant that the latching of the load contacts SW1 does not depend on the application of mains power to the live and neutral supply conductors L, N. The supply conductors L, N pass through the toroidal core 20 of a current transformer CT en route to a load LD and form the primary windings of the CT (the term “winding” is used in accordance with conventional terminology even though the conductors pass directly through the core rather than being wound on it). The output of the current transformer, which appears across a secondary winding W1, is fed to an RCD integrated circuit (IC) 100, which may be a type WA050 supplied by Western Automation Research & Development and described in U.S. Pat. No. 7,068,047. The IC 100 is supplied with power via a diode D1 and resistor R3.

In the absence of a residual (ground fault) current, the vector sum of the currents flowing through the core 20 will be zero since the currents flowing in the L and N supply conductors will be equal and opposite; thus the voltage developed across W1 will be zero. The function of the CT and IC 100 is to detect a differential current (i.e. a non-zero vector sum of currents) flowing through the CT core 20 having a magnitude above a predetermined threshold, such threshold corresponding to a particular level of residual current to be detected according to the desired sensitivity of the RCD. When such a differential current is detected the IC 100 provides a high output voltage on line 10 indicating that a residual current fault has been detected, such voltage being sufficient to turn on a normally-off silicon controlled rectifier SCR1 of an actuator circuit 200 indicated by the dashed rectangle in FIG. 2.

The actuator circuit 200 includes SCR1, the coil K1, the diode D1, a resistor R1 and a capacitor C1, and is powered via the diode D1 and the resistor R1. The capacitor C1 will charge up when the RCD circuit is first powered up, and if subsequently a differential current flows through the CT core having a magnitude above a predetermined threshold, the IC 100 will produce an output on line 10 which will turn on SCR1. This will allow C1 to discharge and cause a current having a magnitude above the release threshold to flow through the solenoid K1 in a direction to detrain the plunger (26) from the permanent magnet (22) and open the previously latched load contacts of SW1 and remove power from the load LD.

A key advantage of the ML arrangement of FIG. 2 is that the RCD circuit requires minimal electrical energy for its protective function. As well as mitigating potential temperature rise problems, this can save a considerable amount of energy over the life of the product. However the ML RCD circuit of FIG. 2 suffers a drawback in that in the event of loss of supply neutral the contacts will remain closed but the RCD will be disabled under this condition since both the RCD IC 100 and the actuator circuit 200 are powered from the supply conductors. Thus the user will have no shock protection in the event of touching an exposed live part.

FIG. 2a shows a simple example of an RCD circuit based on an EL type electromagnetic switch operating according to the principles described with reference to FIG. 1 of Irish Patent Application No. S2011/0554 (Attorney Ref: P102912IE01 (ELM SW (WA/60))). Under normal conditions, current will flow from live L to neutral N via diode D1, resistor R1, solenoid coil K and resistor R2. This current will be insufficient to cause the load contacts SW1 to close automatically. SW2 is a manually operated switch biased to the normally open position. When SW2 is closed, resistor R2 will be shorted out and the current flow through coil K will be increased to a level sufficient to cause automatic closing of load contacts SW1. When SW2 is released and opened, the current through coil K will fall to its original value which will be sufficient to keep the switch energised and load contacts SW1 closed. In the event of a residual current fault SCR1 will be turned on and coil K will be shorted out, causing the load contacts SW1 to open. The load contacts SW1 will also open automatically in the event of loss of either supply conductor or reduction of the mains supply below a certain level.

The EL type RCD circuit depicted in FIG. 2a offers the advantage of protection in the event of a reduction in the mains supply or loss of supply neutral, but has the drawback that the contacts will remain open until manually reset as described even if the neutral and the supply is restored. These drawbacks make this device unsuitable for RCDs used in the fixed installation, e.g., SRCDs. An additional drawback is that the relay based circuit of FIG. 2a continuously consumes a relatively high level of current to maintain the contacts in the closed position, possibly up to twenty times the current consumption of the ML based circuit of FIG. 2. This can contribute to potential temperature rise problems and to relatively high energy consumption over the life of the product.

The switch shown in FIG. 1 has been used successfully in RCD circuits such as that shown in FIG. 2 for many years, for example in RCD socket outlets. However, in recent years a problem has come to light in the USA regarding the mis-wiring of RCD (GFCI) socket outlets. This problem arose largely because such socket outlets often have a facility for “feed-through”, to supply downstream socket outlets.

FIG. 3 shows a typical USA style GFCI receptacle. The socket outlet comprises an insulating housing 40 having AC supply input terminals E, N and L and AC supply feed-through (output) terminals E′, N and L′. The input and output terminals are connected by electrical supply conductors 42 within the housing 40. The housing also contains a conventional socket outlet 44 for a three-pin plug which is connected to the L and N supply conductors.

The housing 40 also includes an RCD circuit including a CT having a core 20 surrounding the live L and neutral N conductors, a secondary winding W1 and an IC 100 providing an output 10 on detection of a residual current fault, as described previously. The RCD circuit also includes an actuator circuit 200, constructed as described for FIG. 2. As stated, the actuator circuit 200 is responsive to an output signal 10 from the IC 100 to open the load contacts SW1 and remove power from the socket outlet 44 and feed-through terminals E′, L′ and N′.

The mains supply is connected to the input terminals E, N and L which, when the load contacts SW1 are closed, will feed the integrated socket outlet 44 and also feed downstream socket outlets (not shown) connected to the feed-through terminals E′, L′ and N′. When correctly wired as shown, the RCD will provide shock protection to the local socket outlet 44 and the downstream socket outlets.

FIG. 4 shows how shock protection is compromised if the RCD socket outlet is mis-wired.

FIG. 4 shows the RCD socket outlet of FIG. 3 where the AC supply has been inadvertently connected to the feed-through terminals E′, N′ and L′, and the downstream sockets have been connected to the supply input terminals E, L and N. In this case, when the load contacts SW1 are closed, all parts of the circuit will have power, and if a test button (not shown but conventionally included in such devices) is operated, the RCD circuit will trip and open the contacts SW1. Thus the installer will feel that the overall circuit is protected. However, it can be seen that although the downstream sockets will have power removed when the contacts SW1 open, the internal socket 44 will not have power removed since it is located upstream of the contacts SW1, and a shock risk will remain on that socket outlet regardless of the state of the contacts SW1.

UL recently introduced a new requirement for GFCI manufacturers to provide means to prevent the operation of a GFCI receptacle in the event of such mis-wiring. This problem does not apply to EL type GFCIs because they can only operate when supplied correctly. However ML types generally need to have special provision made to comply with this new requirement. Manufacturers have adopted various means to address this problem, for example the use of a separate solenoid operated switch which can only be closed when the GFCI is correctly wired, etc. In most cases the GFCI is supplied with the contacts open, and the contacts can only be closed by overriding of a lock-out means when the mains supply is connected to the supply terminals. If the mains supply is connected to the feed-through terminals with the contacts open, power will not be provided to enable deactivation of the lock-out means.

As far as we are aware all of the solutions used to date with ML type devices involve the use of an additional mechanical or electromechanical means to achieve the lockout function or prevent mis-wiring. Such additional means add considerably to cost, complexity and reduced overall reliability.

### SUMMARY

It is an object of the invention to provide an improved electromagnetic switch which can be used in RCD socket outlets to address the problem of mis-wiring, but also has wider applications in electrical equipment safety.

According to one aspect the present invention provides an electromagnetic switch comprising at least one pair of magnetically latchable electrical contacts (12a, 14a) operated by current flowing in an associated coil means (K1, K2), and an electrical circuit arranged to apply a first current in a first direction through the coil means to close the contacts and subsequently to apply a second current in a second, opposite, direction through the coil means to open the contacts.

According to another aspect the present invention provides a mains socket outlet comprising a housing having a mains supply input and feed-through terminals connected by electrical supply conductors within the housing, a socket outlet connected to the supply conductors, a fault detecting circuit arranged to detect a fault in the supply conductors and to provide a corresponding output signal, and an actuator circuit including a set of load contacts in the supply conductors, the actuator circuit being responsive to a said output signal to open the load contacts and remove power from the socket outlet and feed-through terminals, wherein the actuator circuit is connected to and powered by the supply conductors and requires power from the conductors to enable closure of the load contacts, and wherein the connection of the actuator circuit to the supply conductors is made upstream of the load contacts.

“Upstream” refers to the direction within the housing from the feed-through terminals to the AC supply input terminals and “downstream” refers to the direction within the housing from the AC supply input terminals to the feed-through terminals.

“Load contacts” are so-called because according to their state they allow or cut off current flow to an external downstream load.

### BRIEF DESCRIPTION OF THE DRAWINGS

Embodiments of the invention will now be described, by way of example, with reference to the accompanying drawings, in which:

FIG. 1 is a schematic diagram of a prior art electromagnetic (EM) switch.

FIG. 2 is a circuit diagram of a prior art RCD circuit which may incorporate the EM switch of FIG. 1.

FIG. 2a is an example of an RCD circuit based on an EL type electromagnetic switch.

FIG. 3 is a diagram of a prior art RCD (GFCI) socket outlet.

FIG. 4 shows the effect of mis-wiring the socket outlet of FIG. 3.

FIG. 5 is a circuit diagram of an RCD circuit which may be used in the socket outlet of FIG. 3 in a first embodiment of the invention.

FIG. 6 is a schematic diagram of an electromagnetic (EM) switch used in embodiments of the invention.

FIGS. 7 to 12 are further circuit diagrams of RCD circuits which may be used in further embodiments of the invention.

FIG. 13 is a circuit diagram of an over- or under-voltage protection circuit which is a further embodiment of the invention.

FIG. 14 is a schematic diagram of an alternative EM switch which may be used in embodiments of the invention.

FIGS. 15 and 16 are schematic diagrams of improvements to the EM switch of FIG. 6.

### DETAILED DESCRIPTION

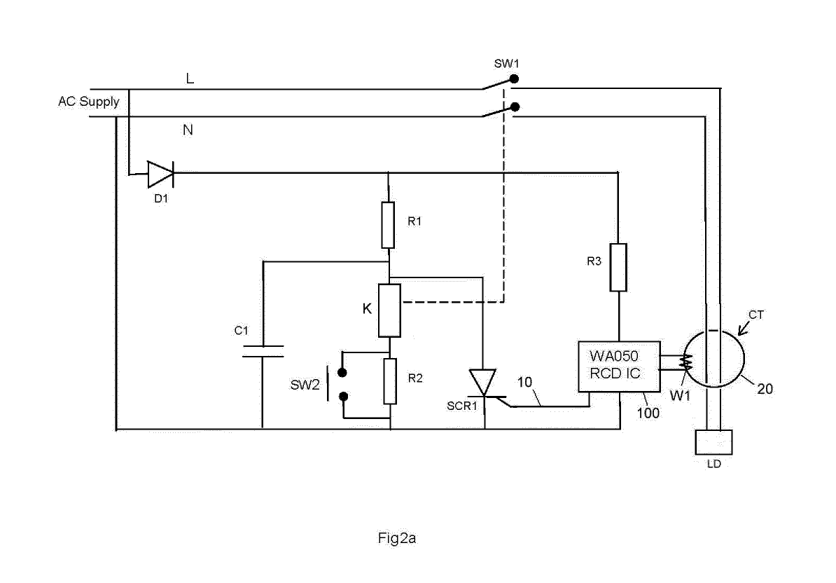

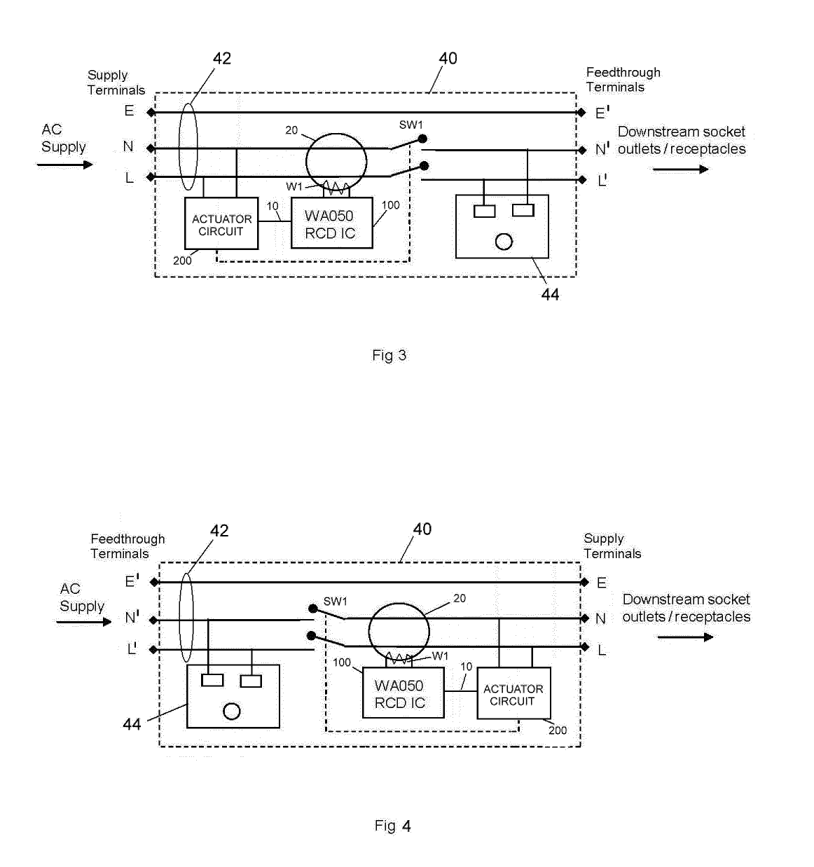

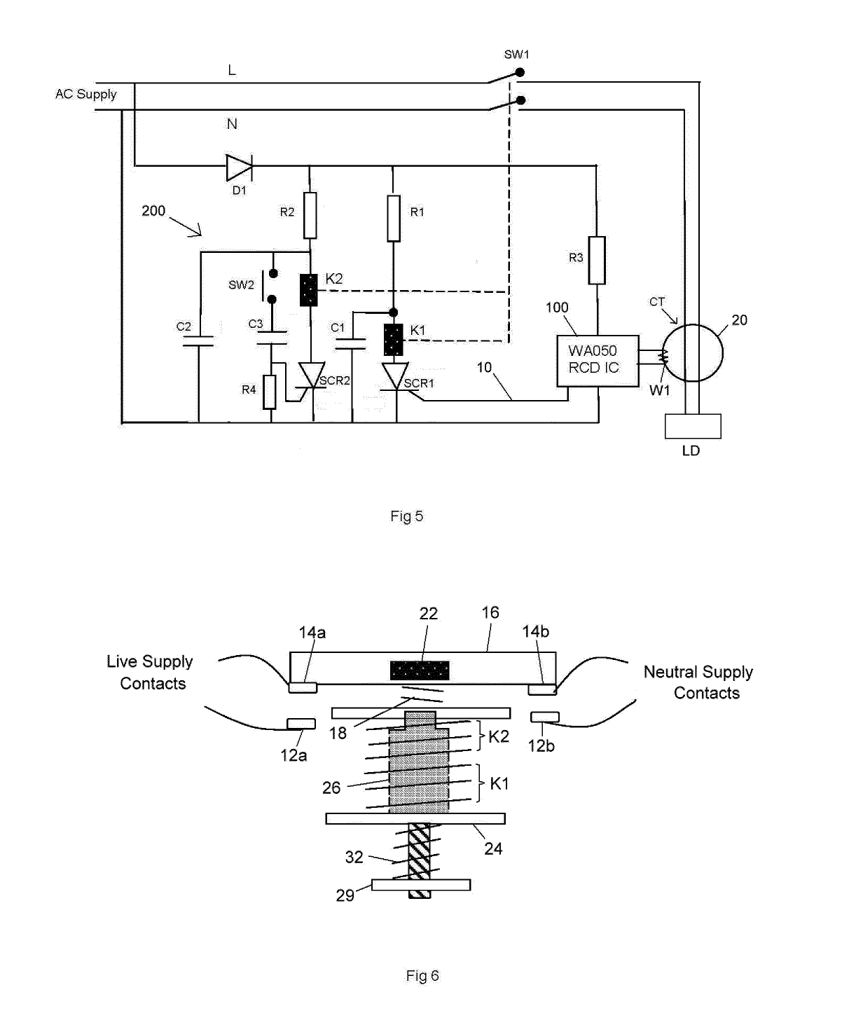

FIG. 5 is a diagram of an RCD circuit which can be used in the RCD socket outlet of FIG. 3 to mitigate the problem of mis-wiring. FIG. 5 is essentially the same as FIG. 2 but with the addition of the following components to the actuator circuit 200: resistors R2 and R4, capacitors C2 and C3, manually operable reset switch SW2, silicon controlled rectifier SCR2 and a second coil K2 on the bobbin 24. In FIGS. 5 and 7 to 12, as well as in FIG. 2, when that circuit is incorporated in an RCD socket outlet, the load LD represents a load connected to the socket 44 or to a downstream socket connected to the terminals E′, N′ and L′ of FIG. 3.

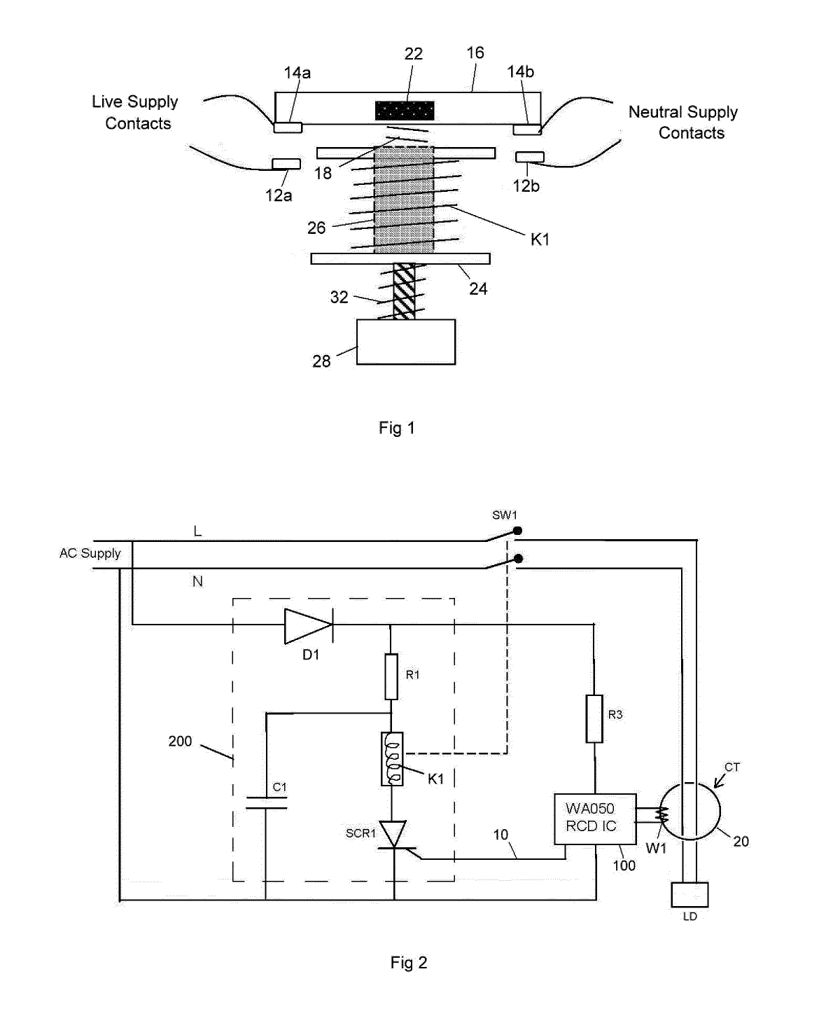

FIG. 6 is a diagram of the EM switch used in the actuator circuit 200 of FIG. 5. In FIG. 6, the reset button 28 of FIG. 1 has been replaced by a retainer, for example a circlip type washer 29, to retain the reset spring 32. The bobbin 24 now has two independent coils, K1 and K2 surrounding the plunger 26. A current passed through coil K2 in a certain direction will generate an electromagnetic force that will increase the existing attraction between the plunger 26 and the permanent magnet 22, and if the current through K2 exceeds a certain threshold the magnet 22 and plunger 26 will be sufficiently drawn towards one another (the movement being primarily that of the plunger moving upwards in the bobbin) as to cause the plunger 26 to engage the MCC 16. In this embodiment the plunger has been reconfigured by provision of a narrow shoulder at its top end to concentrate the electromagnetic flux in the plunger to attract it into the bobbin and towards the magnet when a current is passed through coil K2. As in the case of FIG. 1, the fixed contacts 12a, 12b are preferably spring mounted so that they can yield resiliently upon engagement by the movable contacts 14a, 14b, and it is also preferred that there be a degree of over-travel remaining in the reset spring 32 for the reasons previously stated.

K1 represents the original coil as shown in FIG. 1. In the arrangement of FIG. 5, when the circuit is first powered up, i.e. first connected to the AC supply, C1 charges up via R1 and C2 charges up via R2. SW2 is a manually operable reset switch, and when this is closed a short voltage pulse will be applied to the gate of SCR2 and cause SCR2 to turn on and discharge C2 through coil K2 to cause a momentary surge of current through K2. An additional current will flow through K2 via R2. Coil K2 is arranged on the bobbin such that when SCR2 turns on, the currents flowing through K2 will generate an electromagnetic flux that will add to rather than oppose the flux of the permanent magnet 22. The total current flowing in K2 during the brief period when SCR2 is turned on is sufficient to draw the plunger 26 upwardly into engagement with the MCC 16 against the bias of the spring 32 so that the plunger 26 and the magnet 22 become entrained. After the current burst stops flowing in K2 the reset spring 32 will draw the entrained MCC 16 and plunger 26 downwards until the two sets of contacts SW1 (i.e. 12a, 14a and 12b, 14b) are closed. SCR2 will turn off at the following negative half cycle of the mains supply so the current flow through K2 will be negligible so that even if SW2 is held closed, automatic opening of the contacts will not be impeded by any position of SW2, thus ensuring trip free operation of the GCFI. When SCR1 is turned on by an output signal 10 from the RCD IC 100 current will be drawn through K1 to cause automatic opening of the contacts SW1, as before.

An advantage of the modified plunger arrangement of FIG. 6 is that by electrically drawing the plunger upwardly, entrainment can be achieved with minimal current or energy. However entrainment could also be achieved by a plunger of the kind shown in FIG. 1 provided a sufficiently large amount of current was used to draw the magnet to entrain with the plunger. In another embodiment of the EM switch, not shown, the plunger 28 is fixed relative to the coils K1, K2 and the amplitude of the current flowing in K2 when SCR2 turns on is sufficiently high to enable the plunger 28 to attract the magnet 22 and close the contacts 12a, 14a and 12b, 14b without initial movement of the plunger towards the contact carrier 16.

The RCD socket outlet shown in FIG. 3, incorporating the RCD circuit of FIG. 5 rather than that of FIG. 2, is supplied to the user with the load contacts SW1 open. Since the actuator circuit 200 is connected to and powered by the supply conductors L, N and requires power from those conductors to enable closure of the load contacts SW1, and because the connection of the actuator circuit 200 to the supply conductors is made upstream of the load contacts SW1, any mis-wiring of the RCD socket outlet as shown in FIG. 4 will prevent mains power being applied to the RCD circuit and not allow the load contacts to be closed. This is because direct manual closure is not available, the EM switch and in particular the lower end of the plunger 26 not being accessible externally of the housing 40.

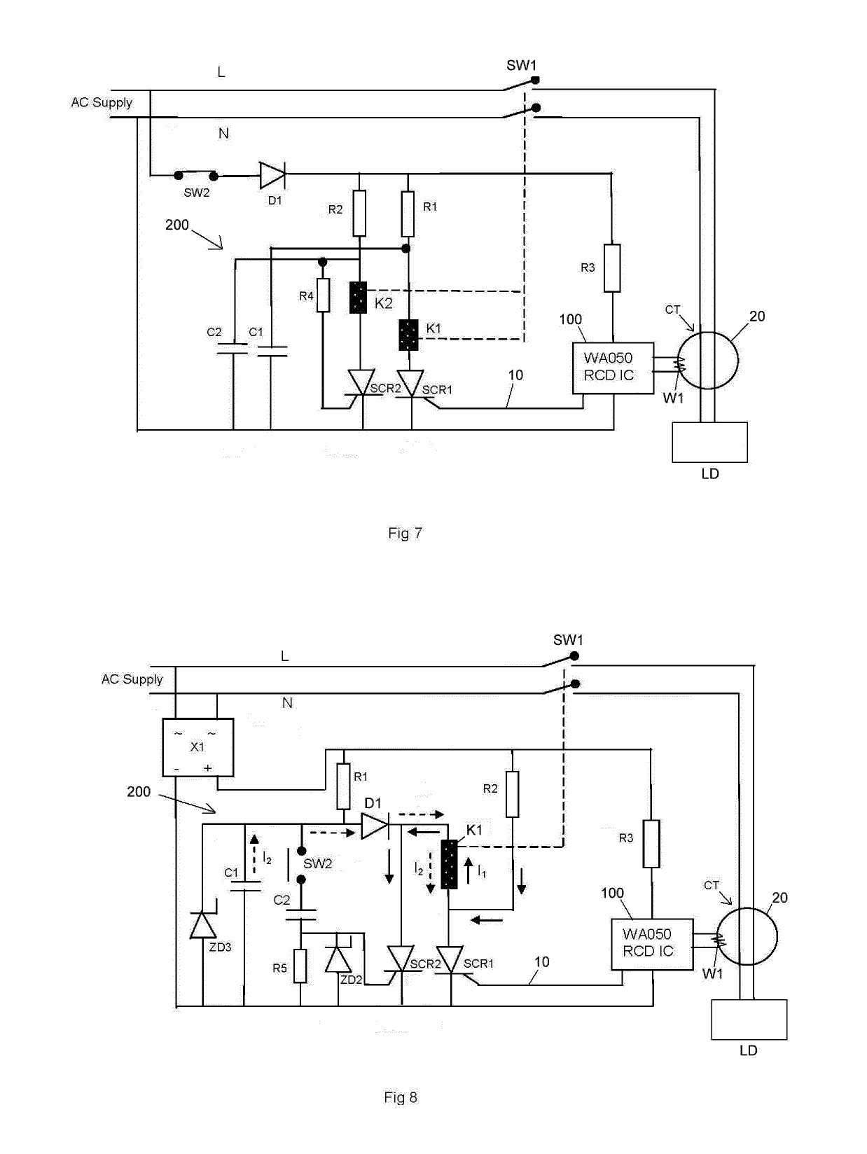

The arrangement of FIG. 5 shows how the resettable EM switch can be closed by the user without the need for direct manual closure of the resettable EM switch. However, the EM switch does require indirect manual closure by pressing the reset switch SW2. If required, fully automatic closing can be achieved by the RCD circuit shown in FIG. 7.

The circuit of FIG. 7 uses the EM switch shown in FIG. 6. When the socket outlet (FIG. 3) is first powered up, capacitor C2 will charge up at a predetermined rate as determined by its value and that of R2. When C2 reaches a certain voltage level SCR2 will turn on and this will cause C2 to discharge through K2 and the current through R2 will now also flow through K2. The resultant current burst is of sufficient magnitude and direction as to cause the plunger 26 to move towards the magnet 22 and ensure entrainment of the MCC 16 and automatic closing of the contacts 12a, 14a and 12b, 14b when the plunger 26 reverts to its original position under the action of the spring 32. SCR2 will turn off at the next negative going half cycle of the supply and may turn on during a subsequent positive half cycle but this will have no effect on the now fully closed switch. In the event of a residual current fault SCR1 will be turned on by an output 10 from the IC 100, and this will discharge C1 through K1, the magnitude and direction of the current flow through K1 causing automatic opening of SW1 contacts as previously described.

In the circuit of FIG. 7, SW2 is arranged as a normally closed switch, and manual opening of SW2 will remove power from the circuit and ensure that SCR1 and SCR2 turn off. When SW2 is reclosed, SW1 contacts will automatically reclose as previously described.

The RCD circuit of FIG. 8 shows how a single coil can be used to achieve the closing and opening functions of the load contacts SW1 using the EM switch of FIG. 6 but with coil K2 omitted. FIG. 8 uses a bridge rectifier X1 as power supply for the RCD IC 100 and the actuator circuit 200 but a single diode may be used instead of the bridge rectifier. Conversely, a bridge rectifier could be used in the embodiments which use a diode.

On power up from the AC supply an initial current will flow from the supply via R1 to charge up C1. Components C2 and R5 form a pulse generating circuit. When SW2 is manually closed the pulse generating circuit will feed a single pulse to the gate of SCR2, causing SCR2 to turn on. This will draw a current I₁ through X1, R2 and K1 for up to one half cycle of the mains supply. This current burst I₁ will be in a first direction as shown by the solid arrows and of sufficient magnitude as to cause the plunger 26 to move towards the magnet 22 and ensure entrainment of the MCC 16 and automatic closing of the contacts 12a, 14a and 12b, 14b when the plunger 26 reverts to its original position under the action of the spring 32. SCR2 will turn off at the following zero-crossover of the mains supply. C1 will then recharge via R1. In the event of a residual current fault an output 10 from RCD IC 100 will turn on SCR1 and cause C1 to discharge via D1 through K1 with a second current I₂, but this time the current I₂ will be in the opposite direction to the current I₁ as shown by the dashed arrows and will weaken the magnetic holding flux between the permanent magnet 22 and plunger 26 and cause the MCC 16 to be released with consequent automatic opening of load contacts SW1. Opening and reclosing of SW2 will enable reclosing of contacts SW1.

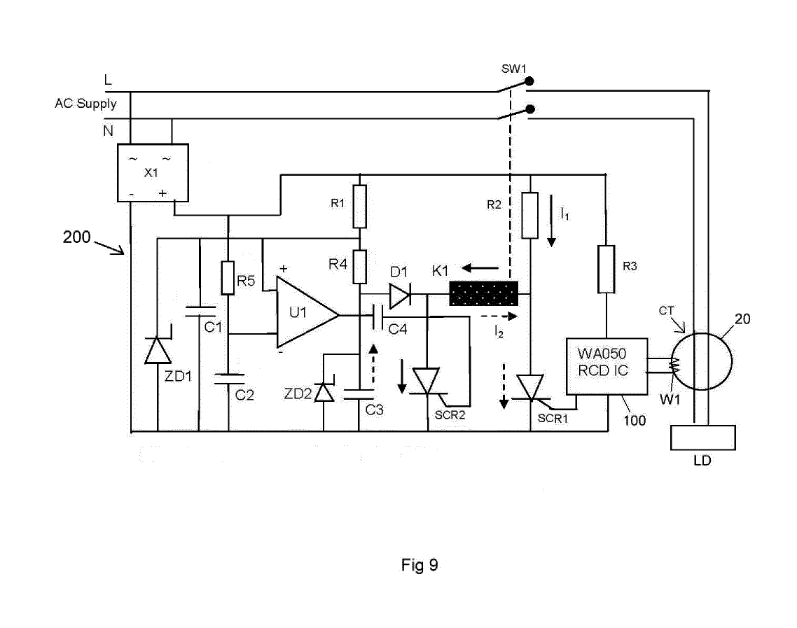

FIG. 9 shows an alternative arrangement for automatic closing and opening of the EM switch, again using the EM switch of FIG. 6 but with coil K2 omitted.

On initial power up from the AC supply, capacitor C1 charges up via X1 and R1. The output of a comparator U1 is initially low, but when the voltage on C1 exceeds a certain threshold, U1 output goes high. The positive going transition produces a positive going pulse which is applied to the gate of SCR2 via C4. SCR2 turns on and draws a current I₁ through R2 and K1, as indicated by the solid arrows. This current burst I₁ will be in a first direction as shown by the solid arrows and of sufficient magnitude as to cause the plunger 26 to move towards the magnet 22 and ensure entrainment of the MCC 16 and automatic closing of the contacts 12a, 14a and 12b, 14b when the plunger 26 reverts to its original position under the action of the spring 32. Capacitor C3 acquires a charge via R1 and R4. In the event of a residual current fault, SCR1 will be turned on by an output 10 from the RCD IC 100 and will cause C3 to discharge via D1, K1 and SCR1 with a second current I₂, but this time the current I₂ will be in the opposite direction to the current I₁ as shown by the dashed arrows and will weaken the magnetic holding flux between the permanent magnet 22 and plunger 26 and cause the MCC 16 to be released with consequent automatic opening of load contacts SW1.

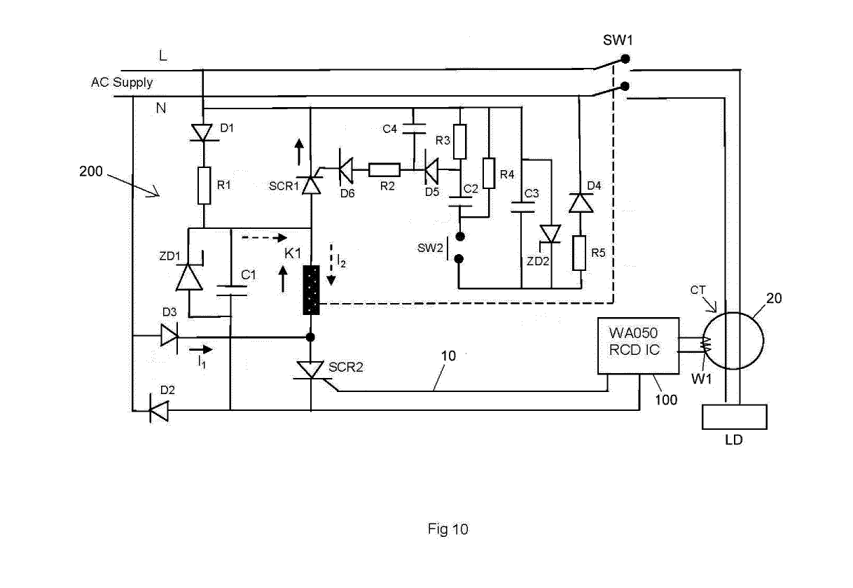

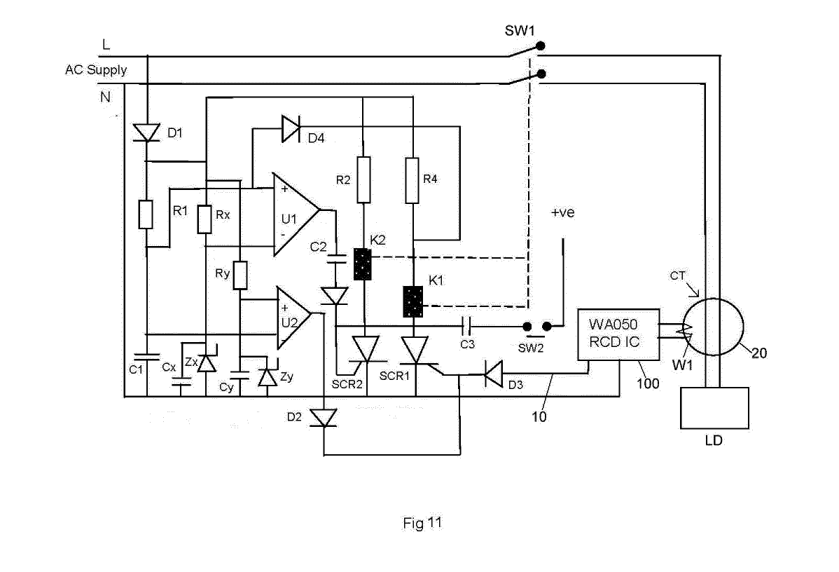

FIG. 10 shows an alternative arrangement for using a single coil to automatically latch and delatch (close and open) the load contacts SW1 (in FIGS. 10 and 11 the power supply to the RCD IC 100 is not shown). The load contacts SW1 are initially open, and when the circuit is correctly connected as shown and AC power is applied, capacitor C3 will acquire a charge via R5 and D4, with ZD2 clamping the voltage on C3. When SW2 is manually closed, a voltage pulse will pass through C2, D5, R2 and D6 to the gate of SCR1 to turn SCR1 on. When SCR1 turns on a current I₁ will flow from neutral N to live L via D3, K1 and SCR1 when neutral is positive with respect to supply Live. Capacitor C4 in combination with D5 acquires and holds a charge from the initial pulse and discharges slowly into SCR1 gate to ensure that SCR1 will turn on immediately or on the occurrence of the next positive going half cycle. The resultant current flow through K1 will be in a direction which will attract the plunger and the permanent magnet in the MCC towards each other so as to reduce this gap sufficiently to cause the open contacts SW1 to close. Although SCR1 will turn off at the next negative going half cycle, the contacts will be held closed by the permanent magnet as previously explained.

In the event of a residual current fault, the RCD IC 100 will produce an output to turn on SCR2 which in turn will cause C1 to cause a current I₂ to flow through coil K1. This current will produce a magnetic flux in opposition to that of the magnet and weaken the hold of the magnet on the plunger so as to cause its release, resulting in automatic opening of the main contacts.

FIG. 11 shows an arrangement for automatically closing and opening the EM switch contacts SW1 in response to predetermined supply conditions.

FIG. 11 shows an arrangement with a window comparator comprising U1 and U2, with Rx/Zx providing a reference voltage on U1 −ve input and Ry/Zy/Cy providing a lower reference voltage on U2 +ve input. When the supply is applied C1 will charge up at a certain rate but the voltage on U1 −ve input will be established almost immediately and thus hold U1 output low initially. Cy will charge up at a slower rate than C1 with the result that U2 output will also be initially low. When the voltage on C1 exceeds a certain level, U1 output will go high which will cause SCR2 to turn on. This in turn will draw a current through K2 and cause the load contacts SW1 to close as previously described. When the mains supply is removed, the voltage on C1 will fall gradually and when it falls below the voltage level on Cy, U2 output will go high turning on SCR1. When SCR1 turns on the resultant current through coil K1 will cause the main contacts to open as previously described. K1 can be activated by the discharge of C1 via D4 or by a current drawn through R4 or a combination of the two currents. In either case it follows that the load contacts SW1 will open automatically in the event of loss of supply live, supply neutral, or a reduction in the supply voltage below a certain predetermined level.

Under normal supply conditions, if a residual fault current occurs, the output 10 of RCD IC 100 will go high and turn on SCR1 and thereby cause the contacts SW1 to open. Subsequent to this event, the contacts SW1 can be manually reclosed by operation of SW2. When SW2 is closed a positive pulse will be applied to SCR2 and turn it on and cause the main contacts to reclose.

As can be seen from the foregoing, the EM switch of FIG. 6 can be used to achieve automatic closing of a set of contacts SW1 when a supply voltage of a predetermined level is applied on the supply side of the contacts, and prevent closing when the supply is connected on the load side of the contacts SW1 provided the switch is contained in a housing which does not allow direct manual closure of the contacts from outside the housing.

The EM switch of FIG. 6 can be used to achieve automatic opening of the contacts SW1 in the event of only one supply conductor being connected, thereby providing protection in the event of loss of supply live or supply neutral conductors.

The EM switch of FIG. 6 can be used to achieve automatic opening of the contacts SW1 in the event of the supply voltage falling below a predetermined level, e.g. in the event of a brown out.

The EM switch of FIG. 6 can be used to achieve automatic opening in the event of loss of supply live or neutral or reduction of the supply voltage below a certain predetermined level and automatic reclosing in the event of restoration of the supply live, neutral or the supply voltage above a predetermined level.

In all embodiments the RCD socket outlet with feed-through terminals and an actuator circuit 200 as shown in any of FIGS. 5 and 7 to 11 will usually be supplied to the user with the load contacts in the open state and with no provision for direct manual closure of the load contacts externally of the housing. If, therefore, the installer connects the mains supply to the feed-through terminals instead of to the supply terminals it will not be possible to close the contacts, so the problem of mis-wiring is mitigated.

Furthermore, with the embodiment of FIG. 11 the RCD will open automatically in the event of loss of supply neutral and reclose automatically on restoration of the supply neutral, so the problem of loss of supply neutral with regard to an ML type RCD is also mitigated.

The EM switch of FIG. 6 does not require any current flow through its coil to retain the contacts in the closed state, and thereby provides the benefits of an EL type switch whilst also providing the benefits of an ML switch whilst mitigating the drawbacks of EL and ML type switches.

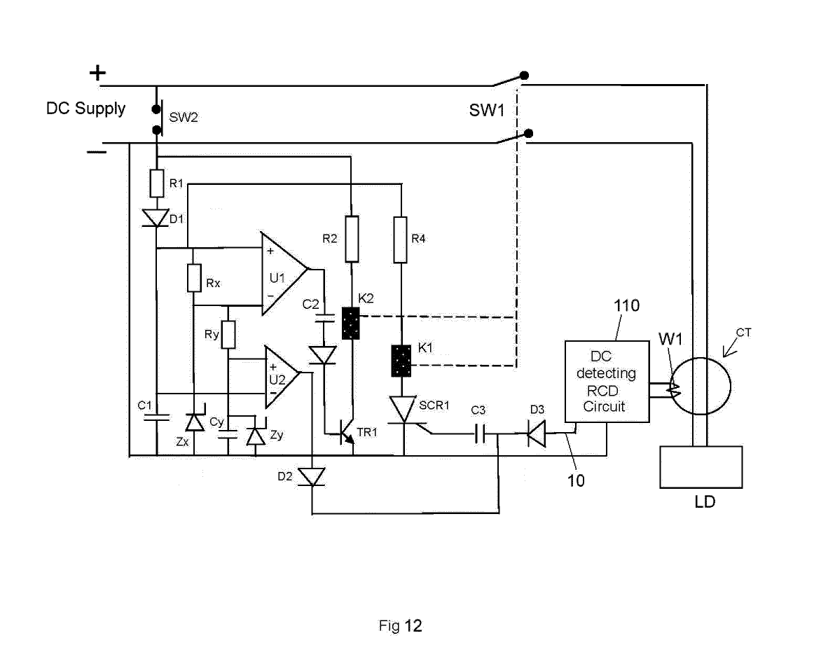

Refinements may be made to the circuit without departing materially from the scope of the invention. For example, the EM switch of FIG. 6 could be used on AC or DC systems, in electric vehicles or solar panels, etc. For example, FIG. 12 shows a DC application of the EM switch of FIG. 6.

FIG. 12 is based on a DC supply, but operates largely on the same principle as FIG. 11 for an AC system. When the DC supply voltage reaches a predetermined level, U1 output goes high and a positive going pulse is applied to transistor TR1 to turn it on momentarily. The resultant current through coil K2 will cause the main contacts to close, as previously described. In the event of a reduction in the supply voltage below a certain level, due for example to a broken supply conductor, U2 output will go high and cause a positive going pulse to be fed to the gate of SCR1 via D2 and C3 and turn SCR1 on, resulting in automatic opening of the load contacts SW1. Restoration of the DC supply will result in automatic reclosing of the load contacts. In the event of a residual current fault, the DC residual current detecting circuit 110 will go high and a positive going pulse 10 will be fed to the gate of SCR1 via D3 and C3. The circuit 110 operates according to the principles described in Patent Application PCT/EP2011/066450 (Attorney Ref: P98463pc00 (Ydo (WA/49)). The pulse 10 will cause SCR1 to turn on and discharge capacitor C1 through coil K1, resulting in automatic opening of the load contacts. SCR1 will remain turned on as long as the supply is present. SW2 is a normally closed switch, and manual opening of this switch will remove the supply and force SCR1 to turn off. Reclosing of SW2 will restore the supply and cause the main contacts to automatically reclose.

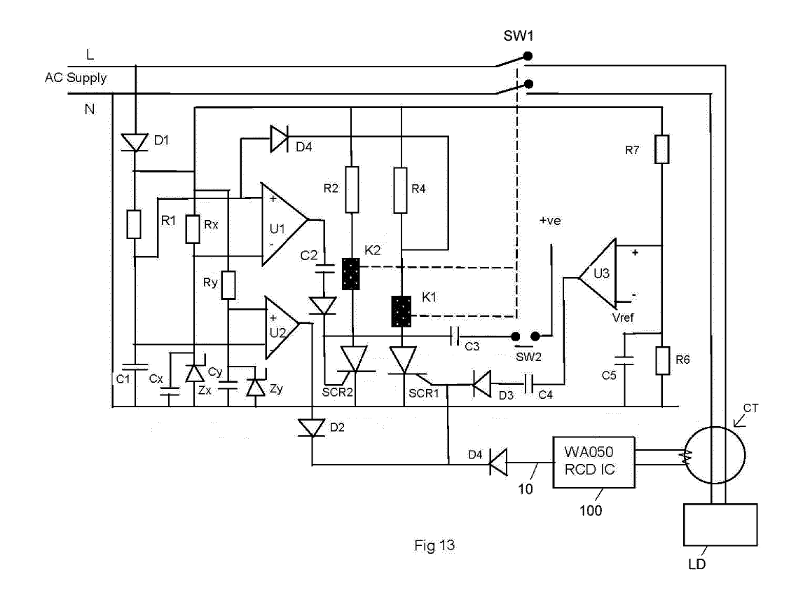

FIG. 13 shows an arrangement for detection of undervoltage and overvoltage conditions.

FIG. 13 is similar to FIG. 11 except that an overvoltage detection circuit has been added. Comparator U3 output has a reference on its −ve input which is higher than the voltage on its +ve input derived from the mains supply via potential divider R6 and R7 under normal supply conditions. Capacitor C5 provides smoothing and a certain time delay before the voltage on U3 +ve input can go high. Thus, under normal supply conditions U3 output will remain low, and the main contacts can close automatically and open under low supply conditions and open under a residual fault condition as before. However, in the event of an abnormally high supply voltage, which could happen if the circuit was connected to a 240V supply when intended for operation on a 110V supply, the voltage at U3 output will go high and the resultant positive output will cause SCR1 to turn on and open the contacts, thus providing protection against a sustained overvoltage condition.

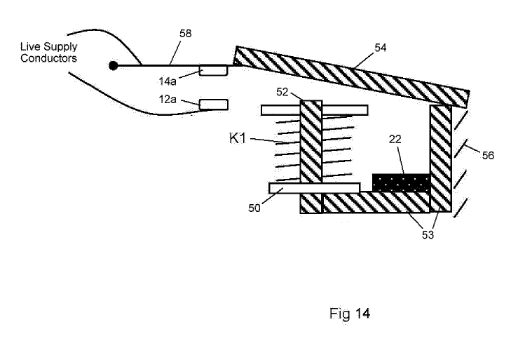

FIG. 14 shows an alternative and more efficient embodiment of the EM switch which can be used in the various circuits described herein in the place of the EM switch of FIG. 6. In FIG. 14 the same references have been used for components equivalent to those of FIG. 6.

The switch comprises a bobbin 50 which is fitted to a ferromagnetic pole piece 52 fixedly mounted on a ferromagnetic frame 53. The frame and pole piece could also be formed from a single piece of ferromagnetic material. A solenoid coil K1 is wound on the bobbin 50, surrounding the pole piece 52. A pivoting ferromagnetic armature 54 is fitted to the top of the frame 53 and is biased into a first, open position (as shown in FIG. 14) by a spring 56. The free (left hand) end of the armature 54 cooperates with a movable contact 14a which is independently mounted on a spring carrier 58. A “fixed” contact 12a opposes the movable contact 14a.

A permanent magnet 22 is located on the frame 53 and induces a flux into the pole piece 52, frame 53 and armature 54 but due to the gap between the armature and pole piece this flux is not strong enough to draw the armature 54 towards the top of the pole piece 52. When a first current I₁ of a certain magnitude is passed in a certain direction through the coil K1, the free end of the armature 54 is drawn towards and engages the top of the pole piece 52 and thereby creates a closed magnetic circuit. Since the magnetic circuit is closed, the flux from the permanent magnet 22 alone is sufficient to hold the armature 54 in the closed position on termination of the first current I₁. In moving to the closed position, the armature 54 resiliently deflects the moving contact 14a downwards to press against the fixed contact 12a. The closed contacts 12a, 14a provide power to the load LD as before (it is to be understood that fixed and movable contacts 12b, 14b are also present but not shown, and are opened and closed by the same armature 54 simultaneously with the contacts 12a, 14a.

When a second current I₂ of sufficient magnitude is passed through coil K1 in the opposite direction to that of the first current I₁, the magnetic flux will be sufficiently weakened as to release the armature 54 and enable the armature 54 and the moving contact 14a to revert to their open states under the action of the spring 56.

It will be seen that one difference between FIG. 6 and FIG. 14 is that in the former the movable contacts 14a, 14b are mounted on the contact carrier 16, whereas in FIG. 14 the movable contact 14a is independently mounted and resiliently deflected by the armature onto the fixed contact 12a. It will be understood that in FIG. 6 the movable contacts could likewise be independently mounted and resiliently deflected into engagement with the fixed contacts. Conversely, the movable contacts 14a, 14b of FIG. 14 could be mounted on the armature, similarly to FIG. 6.

The arrangement of FIG. 14 is more efficient than that of FIG. 6. It differs from that of FIG. 6 in that the permanent magnet does not move, and it uses a closed magnetic circuit. Nonetheless it operates essentially on the same principle of using a first current through a coil to close a set of contacts and using a permanent magnet to hold the contacts closed after expiry of the first current, and using a second current in the opposite direction to the first current to open the contacts.

The present invention describes a simple, reliable and cost effective technique for use of a resettable EM switch to mitigate the problem of mis-wiring in a socket outlet with feed-through terminals. Furthermore, the solution is effective each time the device is wired up and thereby facilitates removal and rewiring of the device without subsequent risk of mis-wiring. However, the switch has a wider application, as described above. For example, the invention may be used in portable devices and in panel mounted devices, and may be used in DC systems or in TN, TT or IT AC systems.

It will be seen that as embodiments of the present invention do not require a mechanical reset button such as the button 28 of FIG. 1 to close the contacts SW1, the housing 40 can in general be sealed. Whereas in conventional RCD or GFCI devices, a button is used to reset the device, in embodiments of the present invention, the reset switch SW2 of FIGS. 5, 7, 8 and 10-13 as well as any test switch (not shown) can be implemented with, for example, a membrane keypad affixed to the external surface of the housing and connected to the remainder of the circuitry by, for example, a flexible tape passing through a slot of minimal dimensions in the housing. Using such a membrane means that the device can be operated even by users who may find difficulty accessing and operating within the limited space typically afforded to RCD/GFCI devices in panels. It also means that no space needs to be allowed for mechanical movement of a reset button so providing for greater flexibility in the overall design of the housing,

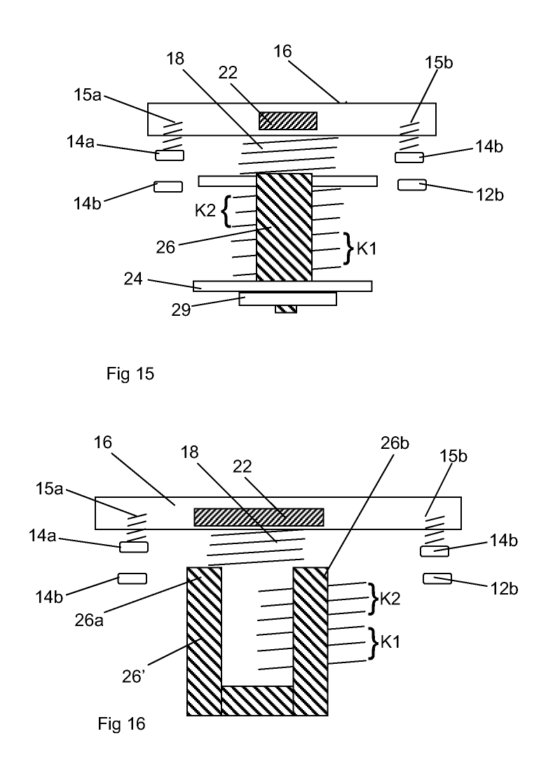

The arrangement of FIG. 6 can be modified as shown in FIGS. 15 and 16 to improve the performance and efficiency of the switch.

In the arrangement of FIG. 15, the pole piece 26 is fixed and retained in position by the retainer 29. When a current of sufficient magnitude is passed through coil K2, an electromagnetic flux will be induced into the pole piece and will be of such polarity or direction as to attract the permanent magnet 22 towards the pole piece. When the current in K2 is of sufficient magnitude the permanent magnet will become magnetically entrained to the pole piece such that when the current in K2 is removed the permanent magnet 22 and the pole 26 piece will remain entrained due to the flux of the permanent magnet. During this process the MCC 16 and its associated contacts 14a,14b will move towards the fixed contacts 12a,12b. In this embodiment, the MCC contacts are fitted with biasing springs 15a, 15b so as to bias them towards the fixed contacts. When the moving and fixed contacts touch, the MCC contacts will be deflected upwards until the permanent magnet 22 and the pole piece 26 become entrained, at which state the biasing springs 15a,15b will ensure adequate pressure between the fixed 12a, 12b and moving contacts 14a,14b to ensure reliable operation under the required operating current and voltage conditions. The biasing springs 15a,15b also ensure that there will be adequate contact pressure even after a certain amount of wear on either the fixed or moving contacts. When a current of a certain magnitude and direction is passed through coil K1, the holding flux of the permanent magnet will be sufficiently reduced so as to cause the permanent magnet 22 and MCC 16 to move to their open position due to the force of the opening spring. The arrangement of FIG. 15 simplifies the solenoid design and assembly and provides more optimal contact pressure on each set of contacts.

The arrangement of FIG. 15 can be further improved by the arrangement of FIG. 16. In the arrangement of FIG. 16, the pole piece 26′ now comprises a U shaped part rather than a rectangular or cylindrical part, the U shaped part having two ends 26a, 26b facing a permanent magnet. When a current of a certain polarity and magnitude is passed through coil K2, the permanent magnet will be drawn towards and will entrain with the pole piece and the two sets of contacts will close as described for FIG. 15. However, the arrangement of FIG. 16 provides a closed magnetic circuit which ensures that virtually all of the permanent magnet flux is harnessed to provide the holding force and contact pressure, leading to improved performance and efficiency. In the case of a dual coil system, the coils K1, K2 may be placed on a single arm as shown, or placed on the separate arms if preferred. The bobbin 24 of FIG. 15 has been omitted from FIG. 16 because it is not an essential requirement.

The invention is not limited to the embodiments described herein which may be modified or varied without departing from the scope of the invention.

1. An electromagnetic switch comprising at least one pair of magnetically latchable electrical contacts (12a, 14a) operated by current flowing in an associated coil means (K1, K2), and an electrical circuit arranged to apply a first current in a first direction through the coil means to close the contacts and subsequently to apply a second current in a second, opposite, direction through the coil means to open the contacts.

2. An electromagnetic switch as claimed in claim 1, comprising a movable member (16) including a first ferromagnetic body (22), at least one movable electrical contact (14a) associated with the movable member (16), at least one fixed electrical contact (12a) opposing the movable electrical contact (14a), a second ferromagnetic body (26) disposed within the coil means (K1, K2), at least one of the first and second ferromagnetic bodies comprising a permanent magnet, and a first resilient means (18) biasing the movable member (16) away from the fixed contact (12a), wherein the first current is of a magnitude and direction as to cause relative movement of the second ferromagnetic body (26) and the first ferromagnetic body (22) towards one another such that the movable contact (14a) is brought into engagement with the fixed contact (12a), and wherein the second current is of a magnitude and direction as to sufficiently weaken the magnetic attraction between the first and second ferromagnetic bodies (22, 26) as to allow relative movement of the movable member (16) and second ferromagnetic body (26) away from one another under the action of the first resilient means (18) and the fixed and movable contacts (12a, 14a) to disengage.

3. An electromagnetic switch as claimed in claim 2, wherein the second ferromagnetic body (26) is fixed relative to the coil means, and the movable member (16) moves towards and away from the second ferromagnetic body (26) to close and open the contacts.

4. An electromagnetic switch as claimed in claim 2, wherein the second ferromagnetic body (26) is movable relative to the coil means towards and away from the movable member (16), and wherein the first resilient means (18) biases the movable member (16) towards a rest position away from the fixed contact (12a), the switch further including a second resilient means (32) biasing the second ferromagnetic body (26) towards a rest position away from the movable member (16), wherein the first current is of a magnitude and direction as to move the second ferromagnetic body (26) towards the first ferromagnetic body (22) such that the second ferromagnetic body (26) and the movable member (16) become entrained and upon termination of the first current the second resilient means (32) draws the movable contact (14a) into engagement with the fixed contact (12a), and wherein the second current is of a magnitude and direction as to sufficiently weaken the magnetic attraction between the first and second ferromagnetic bodies (22, 26) as to allow the movable member (16) and second ferromagnetic body (26) to separate under the action of the first and second resilient means (18, 32) and each to return to its rest position.

5. An electromagnetic switch as claimed in claim 2, wherein the movable contact (14a) is mounted on the movable member (16).

6. An electromagnetic switch as claimed in claim 2, wherein the movable contact (14a) is resiliently mounted independently of the movable member (16) and is deflected into engagement with the fixed contact (12a) by the movable member.

7. An electromagnetic switch as claimed in claim 2, wherein the second ferromagnetic body comprises the combination of a ferromagnetic pole piece (52) extending from a ferromagnetic frame (53), the pole piece being disposed within the coil means (K1), and wherein the movable member comprises a ferromagnetic armature (54) pivoted to the frame (53) and resiliently biased away from the pole piece (52).

8. An electromagnetic switch as claimed in claim 1, wherein the coil means comprises first and second independent coils (K1, K2) and the first and second currents flow in opposite direction in the first and second coils respectively.

9. An electromagnetic switch as claimed in claim 1, wherein the coil means comprises a single coil (K1) and the first and second currents flow in opposite directions in the single coil.

10. An electromagnetic switch as claimed in claim 2, wherein the end of the second ferromagnetic body nearest the first ferromagnetic body has a reduced cross-sectional area to concentrate the magnetic flux in the gap between the two.

11. An electromagnetic switch as claimed in claim 1, wherein the electrical circuit derives power from a plurality of electrical supply conductors each having a respective pair of latchable contacts in series therewith, the arrangement being such that the first current cannot be generated to close the contacts in the absence of power on the supply conductors or if the voltage on the supply conductors deviates from a nominal value by more than a certain amount.

12. An electromagnetic switch as claimed in claim 11, wherein if the contacts are closed the electrical circuit is further arranged to open the contacts if the power on the supply conductors fails or if the voltage on the supply conductors subsequently deviates from said nominal value by more than said certain amount.

13. An electromagnetic switch as claimed in claim 11, further including means for detecting a residual current fault on the supply conductors and generating a corresponding output, the electrical circuit being arranged to open the contacts in response to such output.

14. An electromagnetic switch as claimed in claim 1, wherein the switch is contained in a housing which does not allow direct manual closure of the contacts from outside the housing.

15. An electromagnetic switch as claimed in claim 14 comprising one or more of a reset or a test switch mounted externally of the housing and in electrical connection with the electrical circuit, said switch being incorporated in a membrane keypad.

16. A mains socket outlet comprising a housing having a mains supply input and feed-through terminals connected by electrical supply conductors within the housing, a socket outlet connected to the supply conductors, a fault detecting circuit arranged to detect a fault in the supply conductors and to provide a corresponding output signal, and an actuator circuit including a set of load contacts in the supply conductors, the actuator circuit being responsive to a said output signal to open the load contacts and remove power from the socket outlet and feed-through terminals, wherein the actuator circuit is connected to and powered by the supply conductors and requires power from the conductors to enable closure of the load contacts, and wherein the connection of the actuator circuit to the supply conductors is made upstream of the load contacts.

17. A mains socket outlet as claimed in claim 16, wherein the actuator circuit includes a magnetically-latched electromagnetic (EM) switch controlling the load contacts, and wherein initially open load contacts are latched closed by a current passing in a first direction through a coil of the EM switch.

18. A mains socket outlet as claimed in claim 17, wherein the load contacts are opened in response to an output signal from the detecting circuit by a current passing in a second direction, opposite to the first direction, through a coil of the EM switch.

19. A mains socket outlet as claimed in claim 18, wherein the currents passing in the first and second directions flow through the same coil of the EM switch.

20. A mains socket outlet as claimed in claim 18, wherein the currents passing in the first and second directions flow through different coils of the EM switch.

21. A mains socket outlet as claimed in claim 16, wherein the fault detecting circuit is arranged to detect a residual current fault.

22. A mains socket outlet as claimed in claim 16, wherein the socket outlet is contained in a housing which does not allow direct manual closure of the contacts from outside the housing.
